(19) United States
(12) Patent Application Publication
(10) Pub. No.: US 2007/0203845 A1
(43) Pub. Date: Aug. 30, 2007

(54) Method and system for creating multimedia

(75) Inventors: Daniel E. Gross, East Bethany, NY (US); Joseph A. Manico, Rochester, NY (US); John R. Fredlund, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/362,402

(22) Filed: Feb. 24, 2006

(51) Int. Cl. G06Q 99/00

(52) U.S. Cl. 705/59

(57) ABSTRACT

A method and system for providing licensed content to a user is provided, wherein the method and system allow the user to create multimedia including licensed content by providing access to licensed content; tracking the licensed content accessed, an associated provider or providers for the accessed licensed content, the number of times the licensed content was accessed, and a license fee associated with use of the licensed content; combining the licensed content with user-provided content; recording the combined content to one or more user-indicated medium; and calculating a service fee, including one or more license fee, for use of the licensed content and system.

### FIELD OF THE INVENTION

A system and method for creating multimedia including licensed and user-provided content is described.

### BACKGROUND OF THE INVENTION

In today's society, computer and internet usage are prevalent, providing access to many different stimuli, including music, still and moving images, text, graphics, and digitally created works. With advancing technology, combining different publicly or commercially available works for personal use is becoming easier.

Various systems exist for combining certain types of works. For example, different music pieces can be collected onto a CD, a mobile phone, a personal music device such as an MP3 player or Ipod®, a personal computer or laptop, a handheld personal digital assistant, or other devices to form a personalized music collection. Sound files as well as music can be compiled by readily available programs. Commercial services include that offered by Starbucks® for its customers to create a customized CD. Other systems, such as that provided by Wherever Media (www.wherever-media.com/), allow downloads of videos, music, e-books, or other digital media to a user's portable media player or laptop for a fee. Cinema Now allows downloads of movies from the internet (www.cinemanow.com).

An entire industry has developed around karaoke. There exist numerous recording devices for recording the person's voice with the background music. See, for example, JP 2004-139119 and JP 2005-215303. This has also been applied to greeting cards for specialized occasions, as set forth in U.S. Patent Application Publications US 2003/0182827 A1 and US 2005/0102867 A1.

Similar systems exist for images. US 2002/0147661 A1 discloses a method of delivering sample images, with associated instructions on how to purchase originals, through email or other electronic means. The system includes a method of tracking the image provider, and distributing payment to the provider. U.S. Pat. No. 6,370,280 B1 is a system for secure production of composite images, wherein the system includes rules pertaining to copyright identification and controlled reproduction of copyrighted images as part of the composite image. Ulead (www.ulead.com) provides a program for processing personal photos or videos, including adding clip art that comes with the software. Select music or voice tracks can be added as a background to a photo slideshow or movie. OBLO Multimedia (Italy) offers zero, a multimedia photo kiosk, for combining photos and music from a set list of selections in a format suitable for television viewing (www.oblo.biz). U.S. Pat. No. 5,459,819 discloses a system and method for combining a prestored digital image with a digital generated image to produce unique, merged images. Photo booth kiosks are also known for merging the user's image with a computer generated background image as shown, for example, in U.S. Pat. Nos. 5,913,019 and 5,623,581.

Other multimedia systems and devices for combining multiple types of input, most commonly, audio and visual input in the form of photographs or videos and music or voice files include WO 02/052565A1, and U.S. Patent Application Publications US 2003/0007784 A1 and US 2004/0114904 A1.

The above programs and systems all presume the user has rights to the media being accessed and combined, for example, where the user provides the media, or provides a set selection of media for a fee that is rolled into the user fee. These programs and systems therefore limit the selection of material to that available with the program or system, or to user-provided content, or ignore the need for valid licenses to copyright-protected works. For simplicity, where various works are offered to the user, they are either made available under a specific license agreement the program or system provider has established with one or more licensed content provider, or the media is proprietary, such as customized digital art.

There is a need to provide consumers with a wider selection of media from which multimedia compilations can be made, while protecting the intellectual property interests of licensed content providers by paying them an appropriate licensing fee for each use of licensed content.

### SUMMARY OF THE INVENTION

A method and system for providing licensed content to a user is disclosed. The method comprises accessing licensed content; tracking the licensed content accessed, an associated provider or providers for the accessed licensed content, the number of times the licensed content was accessed, and a license fee associated with use of the licensed content; combining the licensed content with user-provided content; recording the combined content to one or more user-indicated medium; and calculating a service fee including one or more license fee.

The system comprises access to licensed content; a tracking system capable of recording the licensed content accessed, an associated provider or providers, the number of times the licensed content was accessed, and a license fee associated with use of the licensed content; a recording system for combining user-provided content with the licensed content and recording the combined content to one or more user-indicated medium; and a calculator for calculating a service fee including one or more license fee.

The method and system can further verify user rights to user-provided licensed content, issue warning messages for non-authorized use of licensed content, rank accessed licensed content by frequency of use, categorically suggest licensed content, charge fees and receive payment for the service, and distribute funds to the licensed content provider or providers.

### BRIEF DESCRIPTION OF THE DRAWINGS

FIG. 1 is a flow chart of an embodiment of a method of the invention;

FIG. 2 is a diagrammatical view of an embodiment of a system of the invention;

FIG. 3 is a diagrammatical view of an embodiment of a system of the invention; and

FIG. 4 is a flow chart of an embodiment of a method of the invention.

### DETAILED DESCRIPTION OF THE INVENTION

A method and corresponding system for combining user-provided content with licensed content are provided. The invention may alternately be referred to as a system or a method, with the understanding that some hardware may be necessary in order to practice the method.

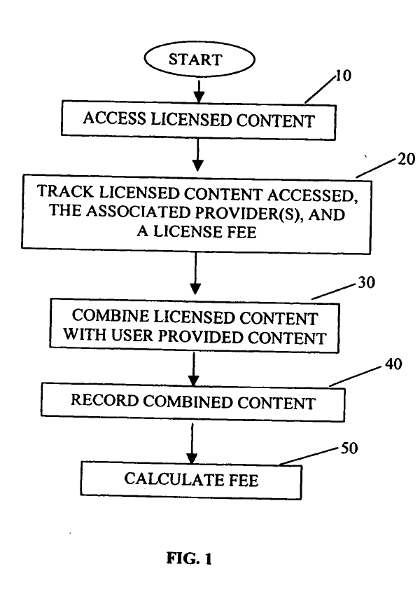

As shown in FIG. 1, the method includes accessing licensed content 10; tracking the licensed content accessed, an associated provider or providers for the accessed licensed content, the number of times the licensed content was accessed, and a license fee associated with use of the licensed content 20; combining the licensed content with user-provided content 30; recording the combined content to one or more user-indicated medium 40; and calculating a service fee including one or more license fee 50.

Licensed content is any work protected by intellectual property rights, such as a copyright, trademark, or service mark, where a license is required for legal copying and reproduction of the work. Licensed content can be provided by an authorized provider having rights to distribute the licensed material. The authorized provider can be the owner or author of the licensed work, or can be a licensee with distribution rights. Non-licensed content as used herein includes works in the public domain, for example, government generated works, texts and images from published patents and patent applications, and user-generated original works. User-provided content is any work provided by the user, whether self-generated, used with owner's permission, or licensed (referred to herein as user-provided licensed content). The licensed content and user-provided content can each be selected from audio and visual works. Visual works can include, for example, text, symbols, images, videos, and movies. Images can include those from a digital camera, digitized film images, drawings, graphic designs, photographs, a video frame or frames, digitally generated works, or scanned works such as text, drawings, or photographs. Audio works can include, for example, sound tracks, vocal tracks, music, computer-generated audio files, and digitized input from musical instruments.

The combined content is the resultant mixture of licensed content and user-provided content. All of the combined content can be licensed content provided by the user, or it can include accessed licensed content, or non-licensed content.

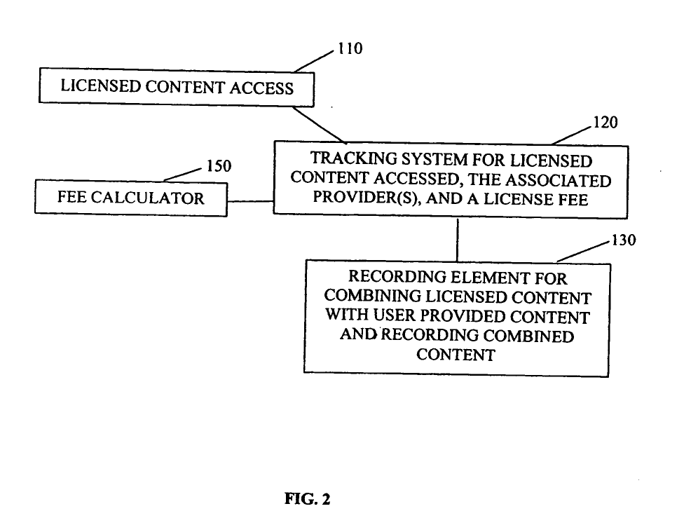

The system for combining licensed and user-provided content, as shown in FIG. 2, can include access to licensed content 110; a tracking system capable of recording the licensed content accessed, an associated provider or providers, the number of times the licensed content was accessed, and a license fee associated with use of the licensed content 120; a recording system for combining user-provided content with the licensed content and recording the combined content to one or more user-indicated medium 130; and a calculator for calculating a service fee including one or more license fee 150.

The licensed content can be provided by the user or an associated provider. An associated provider is an authorized provider that has agreed to provide licensed content to system users. An associated provider can have a pre-existing agreement with the system provider, or can accept requests for access to licensed content from the system in real time.

The tracking system can include a computer or server with memory sufficient to track what licensed content was accessed; for each licensed content, if the licensed content was from an associated provider, the name or a unique designator of the provider, such as, for example, a business ID code, vendor number, or symbol; the number of times each particular licensed content was accessed; and a license fee charged by the associated provider for that specific licensed content. The number of times a licensed content was accessed can be tracked by the number of times a user actually accessed that licensed content on an associated provider's site, the number of times the accessed licensed content is recorded to user-indicated media, or a combination thereof. The system can retain the accessed licensed content, or a marker therefore, in memory during the time of a user transaction such that the site of the associated provider need only be accessed once for the licensed content, but the licensed content can be used one or more times by a user, and recorded one or more times to user-indicated media The user-indicated medium can be, for example, a compact disk (CD); a digital video disc (DVD); a floppy disk; an optical disk; digital or analog tape; a portable memory device; local memory; a particular internet site such as a web-page or subscription service; a computer; a remote server; or a printable receiver. A portable memory device can be a laptop computer, cell phone, digital camera, video camera, personal computer card (PC card), a PCMCIA card (based on the specifications of the Personal Computer Memory Card International Association), a personal digital assistant, flash drive, or a memory card, or a portable media player such as an MP3 player, Ipod®, or device capable of recording and playing back media, such as the KODAK Easyshare Picture Viewer.

More than one medium can be designated by the user for recording of the combined content. For example, the combined content can be recorded on one or more CD or DVD, uploaded to an internet site, and stored on a memory device, portable media player, or laptop of the user.

The connection to the user-indicated medium can be through interaction with a physical device such as a read/write apparatus for a CD, DVD, floppy disk, optical disk, or tape; a memory card slot; a printer; a USB cable; or a serial cable. The connection can be through the internet by any known access means including cable, modem, satellite, and wifi. The connection can be infrared or wireless connection.

The service fee can include one or more license fee for licensed content provided by an associated provider, a charge for use of the system, a site charge imposed by the site owner, a media fee if the user purchases media at the site, taxes, or any combination thereof. A pro-rated license fee can be applied if the user already has an account with the associated provider, or if the user is purchasing a certain amount of licensed content from the same associated provider. A pro-rated system usage charge can be applied if the user is a frequent user, has a coupon or other discount, or has a service contract for a user account. The service contract could provide a set number of recordings, a set number of licensed content access, or some combination thereof, with or without accounting for license fees in the system usage charge. The license fees can be set by the individual associated providers, or can be negotiated between associated provider and the system provider.

The calculator for calculating the service fee due can be the micro-processor based unit, a separate micro-processor based unit, a unit dedicated to fees, part of the tracking system, or an independent unit not part of the system, for example, a register or desk-top calculator at a retailer's sales counter. The calculator can be local, or can be remote from the system. It can be hosted in local memory, on a remote server, be connected to the system by wired or wireless communication, or be completely unattached to the system. Where the calculator function is performed by the retailer, the retailer can be informed of the tracked information through a wired or wireless data transmission, by inspection of the system display, or by a printout of the transactions details.

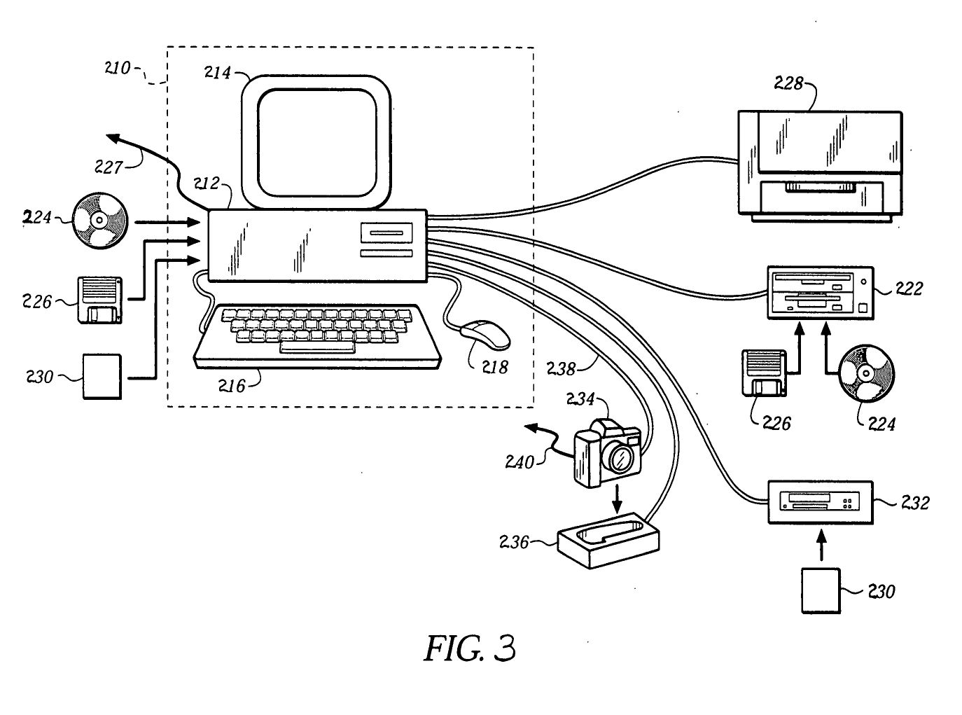

The system can be in the form of a computer and associated peripherals. The computer can be a stand-alone, such as a desktop or laptop computer, or can be part of a kiosk or other display setup. An exemplary system including a computer is shown in FIG. 3.

Referring to FIG. 3, the computer system 210 can include a microprocessor-based unit 212 for receiving and transmitting data and performing processing functions. A display 214 can be electrically connected to the microprocessor-based unit 212 for displaying information to a user, for example, by means of a graphical user interface. The display can be a monitor, television, flat panel display, or other device, such as a personal data assistant, capable of displaying images corresponding to data received from the microprocessor-based unit 212. The display can communicate with the microprocessor-based unit through wired, wireless, or broadcast communication, including radio frequency and infrared communications.

A keyboard 216 can be connected to the microprocessor-based unit 212 for input by a user. As an alternative to using the keyboard 216 for input, a mouse 218 may be used for moving a selector on the display 214 and for selecting an item on which the selector overlays, as is well known in the art. Alternately, input can be through one or more touch-sensor, such as a touch-sensitive display.

Data, including the licensed content and user-provided content, can be entered into the microprocessor-based unit 212 through wired or wireless connection to a data device such as a disk drive 222 capable of reading and/or writing a compact disk (CD), digital video disc (DVD), or optical disc 224, a floppy disk 226, or a memory card reader. The data device can be located internally or externally to the microprocessor-based unit 212. Data can be obtained from digitally or magnetically recorded tapes. Data can be programmed and stored in the microprocessor-based unit 212 in a format accessible for retrieval. Data can be obtained by the microprocessor-based unit 212 through a network connection 227, such as a telephone line, data line, satellite, or cable communication to a network, such as a local area network, a wide area network, or the Internet. Other data devices such as other a computer, a scanner, or a portable memory device 230 such as a laptop computer, cell phone, digital camera, video camera, personal computer card, a PCMCIA card, a personal digital assistant, flash drive, or a memory card, or a portable media player such as an MP3 player, Ipod®, or device capable of recording and playing back media, such as the KODAK Easyshare Picture Viewer, can also be connected to the microprocessor-based unit 212 directly through wired or wireless communication, or through an associated reader 232 internal or external to the microprocessor-based unit 212 for input of data.

Images can be input directly from a digital camera 234 via a camera docking port 236 connected to the microprocessor-based unit 212 or directly from the digital camera 234 via a cable connection 238 to the microprocessor-based unit 212 or via a wireless connection 240 to the microprocessor-based unit 212. Alternately, images can be input through a scanner, videocamera, camera phone, portable media player, or from any of the other possible data sources listed herein. Digital images can also be generated through the use of image generation programs available through any of the above access means.

The system 210 can track information regarding the licensed content, the provider of the licensed content, associated fees, and the number of times and format in which the licensed content is recorded by the user, in the microprocessor-based unit, or through connection to another computer, database, or local or internet server.

Once licensed content and user-provided content are selected, they can be stored temporarily in local memory in the microprocessor-based unit, or on a local network, a local server, a remote server, or in a combination of locations. The content can then be combined as directed by the user by the microprocessor-based unit 212. The microprocessor-based unit 212 can then direct recording of the combined content per user instruction. The microprocessor-based unit 212, or a computing device to which it is connected, can also calculate a service fee owed by the user based on the tracked information.

The combined content can be recorded in local memory in the microprocessor-based unit, on a networked computer or server, or on a remote server such as a server hosting the user's website. The combined content can be recorded in any medium described herein. The combined content can be broadcast, or transmitted by wired or wireless communication to a display. Visual components of the combined content can be printed on a printer 228.

The printer 228 can be used for printing a bill or receipt showing the service fee, whether the fee was paid and by what method. The printer can print copyright information, or a federal copyright protection warning. The printer can be an ink jet, laser, or thermal printer capable of printing on one or more receiver, such as paper, transparencies, transfer media, labels, cloth, postcards, photographic papers, or novelty items of glass, ceramic, or polymeric (plastic) material. The printer can be a printing network including two or more printers of the same or different type. Two or more printers can perform the same function, serially or simultaneously. The printing network can include one or more of a dedicated receipt printer, a text printer, an image printer, and a specialty printer, such as a device for printing decals, stickers, cloth, or other novelty items. Any printer in the printing network can be part of the system, in the same location as the system, or geographically separated from the system. For example, one or more printer can be located at a retailer, at a minilab or other processor, or at a remote location such as the user's home or office. Connection from the system to any printer can be by wired or wireless communication.

The system can also include a payment receipt interface capable of receiving payment of the service fee from the user. The interface can be capable of receiving cash, credit cards, bank cards, debit cards, or personal checks. The interface also can be capable of accessing payment through an internet pay provider, such as Bill-Me-Later or PayPal.

The system can distribute the collected service fee between the providers of licensed content. The distribution can occur per use, daily, monthly, or at any other desired interval. The service fee can include a fee for use of the system to a retail store or location owner in which the system is placed. Distribution between licensed content providers and retail store or location owners can be done electronically through electronic access to bank or transaction accounts, or through a traditional payment service.

It should be noted that the system and method of the invention can be implemented in combinations of software and/or hardware and are not limited to devices that are physically connected and/or located within the same physical location. One or more of the devices illustrated in FIG. 3 can be located remotely and can be connected via a network through wired, wireless, or broadcast communication.

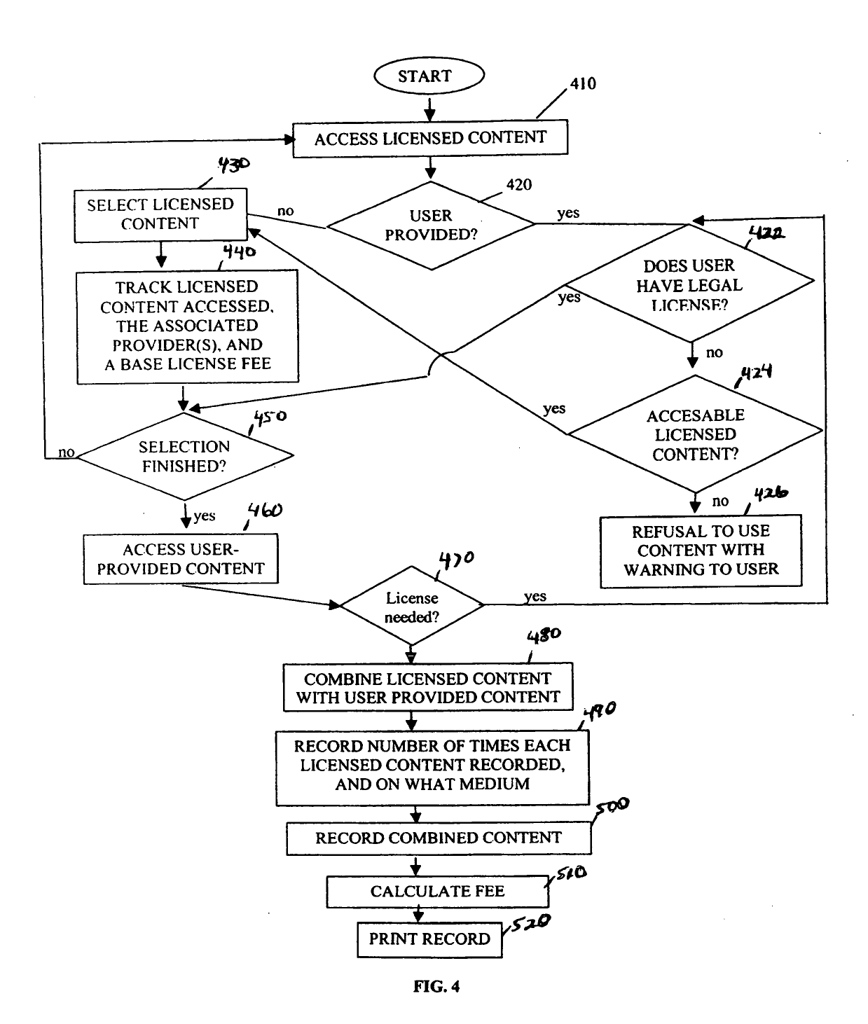

When a user desires to make a recording of combined content, including licensed content, the user can access the system. The system can be on a home computer, or can be a retail installment such as a kiosk. A flowchart of some of the decisions and/or actions of the user is shown in FIG. 4.

The user can access licensed content 410 through the system, or provide user-provided licensed content. The system can determine if the licensed content was user provided 420. If the user does not provide licensed content, the licensed content can be selected 430 by the user, and the selected licensed content can be tracked 440, including tracking for each licensed content the associated provider(s), and the license fee. The user may be prompted whether all desired licensed content has been selected 450. If additional licensed content is desired, the user will return to accessing licensed content 410 through the system, or by providing user-provided licensed content. Once all desired licensed content is accessed, the user can access the user-provided content 460. In alternate embodiments, the user-provided content can be accessed before or between access of desired licensed content. At the end of the process, the system can ask whether all desired content has been accessed, providing an opportunity to access further licensed content or user-provided content.

In the case of licensed content provided by the user 420, or other non-licensed user-provided content, the user-provided content can be examined to determine if the user holds a proper license or rights to the content 422, or if a license is required 470. For example, DVDs and CDs can include digital rights management information, indicating if the CD or DVD was legitimately manufactured, or is an unauthorized copy or homemade medium. Similarly, video and audio files can include status designators. Images can also include authentication marks. Autoidentification and verification of media authenticity can be made through identification of embedded codes or tags, signal strength, histograms, microdots, logos, or other known identification means. The user can be required to present the actual media to the system in a reader capable of accessing digitally stored information, to scan one or more surface of the media to enter a label or identifying mark into the system, or to present the media to a retailer, such as a clerk, if accessing the system in a retail location. If the user's rights to the media are in doubt, and the material is licensed content available through an associated provider, the user can be prompted to use the associated provider's material, paying the license fee. If payment is made at the system through credit card, debit card, or an online service provider, the user could be offered a refund if determined that the user holds proper rights to the media, or the user could be charged a service fee not including the license fee, and later charged the license fee if it is determined the user did not have rights to the media. Rights to the media can be determined by visual inspection of the media by a retailer, who can then enter a verification code into the system, or by a third party remotely connected to the system who receives a scanned image of the media. The user can be asked to agree to a disclaimer asserting that the material is user provided, and any infringement of intellectual property rights is the fault of the user, not that of the system owner/provider.

If the user does not appear to have a license, and the exact or a similar licensed content is available through other input sources, the user can choose to purchase a license for use of the desired content 424. If the user agrees, the content will be accessed and tracked with other licensed content. If the user refuses, the system can refuse to use the accessed or user-provided content 426, or require a disclaimer. If it is determined the desired content, whether accessed or user-provided, is illegal content, the system can refuse to use the content 426. Accessed licensed content can be refused for use if there is no agreement between the system provider and the licensed content provider for payment of license fees 426.

If no license is needed, or it is apparent a legitimate license is held by the user, for example, by use of a commercially purchased CD or DVD, the user can be prompted for instructions or provided options of how to combine the licensed content with user-provided content 480. Methods of forming multimedia recordings are well known in the art. Any available methods can be used to combine selected licensed and user-provided content.

In selecting content, whether licensed or user-provided, the system can provide the user options to aid in searching for desirable content by category. The system can provide identification of possible content source. For example, a lyric, partial title, or audio recording of the user humming a tune, can be used to identify a list of possible songs. Similar methods can be used to find artwork (by description, artist, genre, etc.), texts (subject matter, partial text), and video or still images in associated provider or user-provided media. The system can identify associated works by author, derivative works, works having similar themes or messages, works with the similar visual impact, works of similar sound, or other like common denominators. The found content in the specified licensed content category can be offered to the user either to identify what the user was looking for, or as alternatives or additions to content the user has specified. Where the user has specified a licensed content, and multiple associated providers can provide it, the user can be given a choice of provider, or the system can be programmed to automatically select the associated provider with a preferred factor, for example, lowest cost, best quality, best quality for cost, or popularity.

The system can determine if the associated providers have content similar to user-provided content, but which may be of better quality, and offer such content to a user. For example, if the user has a photograph of a determinable landmark, for example, Epcot Center or Mount Rushmore, stock professional photographs of the locations can be offered as an alternative. Similarly, if user provides a karaoke recording, the system can offer various versions of the original song, as an instrumental or with lyrics, as an alternative.

Once all content is selected and combined as indicated by user, the user can select one or more types of user-provided media 500 for recording. The number of copies can be tracked, and the type of recording medium for each copy can also be tracked 490. Once the recording is finished, a service fee can be calculated 510, which can include the license fee for each licensed content times the number of recordings, scaled for the type of recording media if appropriate, and adding a location fee if desired, for example, in retail installations, as well as any applicable taxes, and deducting any discounts available to user. Charges can be tracked for purchase of recording media, such as CD or DVD, or printable media, from the retailer and included in the service fee. If desired, payment can be collected from the user by the system or a retailer in the form of cash, check, credit card, debit card, bank card, gift card, gift certificate, coupon, internet pay provider, or other payment means.

Depending on the licensed material content, certain forms of recording may not be available in accordance with the license terms. In such cases, a notification will be sent to the user's screen indicating the designated recording media is not allowed. Alternative formats can be suggested by the system.

At any point during the transaction, the user can opt out of the system without payment of fees, or with a minimal user charge, provided no recording of combined content has been made.

Once the transaction is complete, a transaction record can be printed at the location of the system, the user location, or at a retail clerk station, or transmitted to the user, for example, via email, fax, or text message. The transaction record can include the service fee, the breakdown of charges in the service fee, copyright information, a federal copyright law warning, the method of payment, or other information as may be desired. For example, a list of all media, such as audio and video files, used to form the combined content, optionally with attributes to the license provider(s), could be printed or transmitted.

The compilation can be printed, where appropriate, onto any suitable medium, for example, a postcard, photographic paper, transparency, ink jet paper, thermal recording paper, a label, cloth, a transfer medium, or a novelty item, such a t-shirt, cap, mug, picture frame, jewelry, or other item.

An optional feature of the method and/or system includes tracking of each licensed content and ranking licensed content by frequency of use. Such commonly used licensed content can be offered to users before accessing other licensed content. The system can retain a marker or pointer to the most commonly referenced licensed and non-licensed content, or retain copies of such content, including associated provider designation and fee information, in local memory or an accessible server. The system can offer categories of licensed content, such as comedy, drama, children's content, adult content, and the like, and search for category appropriate licensed content and category appropriate unlicensed content in local memory, on a network, the internet, and in user-provided media, and offer the search results to the user.

The system and method described herein enable user-directed compilation of a recording including licensed content and user-provided licensed or unlicensed content. The recording can be a multi-media recording, an audio recording, a visual recording, or a printed object. Fees for use of licensed content are tracked and distributed to appropriate license content providers based on number of copies of the licensed content and the user-provided medium used for recording. Fees related to commercial use of the system, including site fees, and media provision fees, can also be tracked and optionally charged by the system. The system could be integrated into a retailers inventory or charge system for convenience.

The invention has been described in detail with particular reference to certain preferred embodiments thereof, but it will be understood that variations and modifications can be effected within the spirit and scope of the invention.

### PARTS LIST

10 step, access licensed content
20 step, track licensed content, provider, and fee
30 step, combine licensed and user-provided content
40 step, record combined content
50 step, calculate fee
110 licensed content access
120 tracking system for licensed content, provider, and fee
130 recording element
150 fee calculator
210 computer system
212 microprocessor-based unit
214 display
216 keyboard
218 mouse
222 disk drive unit
224 compact disk
226 floppy disk
227 network connection
228 printer
230 portable memory device
232 portable memory device reader
234 digital camera
236 camera docking part
238 cable connection
240 wireless connection
410 step, access licensed content
420 step, determine if user provided
422 step, determine if legal license
424 step, determine if licensed content available
426 step, refuse to use content with warning
430 step, select licensed content
440 step, track licensed content, associated provider, and fee
450 step, determine is selection finished
460 step, access user-provided content
470 step, determine if license needed
480 step, combine licensed and user-provided content
490 step, record number of times each licensed content recorded, and medium
500 step, record combined content
510 step, calculate fee
520 step, print record

1. A method of providing licensed content to a user, comprising:
accessing licensed content;
tracking the licensed content accessed, an associated provider or providers for the accessed licensed content, the number of times the licensed content was accessed, and a license fee associated with use of the licensed content;
combining the licensed content with user-provided content;
recording the combined content to one or more user-indicated medium; and
calculating a service fee including one or more license fee.

2. The method of claim 1, further comprising receiving payment from the user.

3. The method of claim 2, wherein receiving payment comprises charging the service fee and authorizing receipt of the service fee from a credit card, a debit card, a bank card, a personal check, cash, gift card, gift certificate, coupon, or an internet pay provider.

4. The method of claim 2, further comprising distributing the license fee to the associated provider or providers.

5. The method of claim 1, wherein calculating the service fee includes pro-rating the license fee based on the user-indicated medium recorded.

6. The method of claim 1, wherein the licensed content and the user-provided content are independently selected from text, a symbol, an image, a movie or portion thereof, an audio clip, a video clip, or a combination thereof.

7. The method of claim 6, wherein the image comprises a digital or digitized photograph, a drawing, a scanned document, a video frame or frames, a digitally generated object, or a graphic design.

8. The method of clam 1, wherein accessing the licensed content comprises accessing stored licensed content on local memory device or medium, accessing available licensed content through a network connection, or accessing available licensed content through a wireless connection.

9. The method of claim 8, wherein the licensed content comprises user-provided licensed content.

10. The method of claim 9, further comprising verifying user rights to user-provided licensed content.

11. The method of claim 10, further comprising denying access to user-provided licensed content for which user rights are not verified.

12. The method of claim 10, further comprising offering a license fee for use of non-verified user-provided licensed content.

13. The method of claim 1, wherein user-provided content comprises licensed content, non-licensed content, or a combination thereof.

14. The method of claim 1, wherein at least a portion of the user-provided content is non-licensed content.

15. The method of claim 1, further comprising obtaining user-provided content from one or more of local memory, an internet connection, a wireless connection, a remote server, a portable memory device, a compact disk, digital video disk, optical disk, magnetically recorded tape, digitally recorded tape, a computer, or a scanned image.

16. The method of claim 1, further comprising refusing to provide licensed content wherein the associated provider or providers are not authorized.

17. The method of claim 1, wherein the user-indicated medium comprises one or more of local memory; a recordable digital video disc, a recordable compact disc, a recordable optical disc, digitally recordable tape, magnetically recordable tape, a portable memory device, an internet site, a computer, or a printable medium.

18. The method of claim 17, wherein the portable memory device comprises one or more of a laptop, a cell phone, a digital camera, a video camera, a personal computer card, a PCMCIA card, a personal digital assistant, a memory card, a memory stick, a flash drive, or a portable media player.

19. The method of claim 17, wherein the printable medium comprises an ink jet receiver, a thermal print receiver, a laser print receiver, a postcard, a photographic base, a label, a cloth, a transfer medium, or a novelty item.

20. The method of claim 1, wherein tracking the licensed content accessed further comprises storing the licensed content or a marker for the licensed content locally.

21. The method of claim 20, further comprising ranking accessed licensed content by frequency of use.

22. The method of claim 1, wherein accessing licensed content comprises:
selection by the user of a licensed content category;
searching for licensed content in the licensed content category; and
offering search results to the user.

23. The method of claim 22, wherein searching for the licensed content category comprises one or more of searching stored licensed content on a local memory device or medium, searching on a network, and searching user-provided content.

24. The method of claim 1, further comprising printing a transaction record.

25. The method of claim 24, wherein the transaction record comprises one or more of a list of accessed licensed content, the fee for each licensed accessed content, the service fee, copyright information on accessed licensed content, or a federal copyright protection warning.

26. A system for providing licensed content to a user, comprising:
access to licensed content;
a tracking system capable of recording the licensed content accessed, an associated provider or providers, the number of times the licensed content was accessed, and a license fee associated with use of the licensed content;
a recording system for combining user-provided content with the licensed content and recording the combined content to one or more user-indicated medium; and
a calculator for calculating a service fee including one or more license fee.

27. The system of claim 26, wherein access to licensed content comprises access to stored licensed content on a local memory device or medium, access to licensed content through a network connection, or access to licensed content through a wireless connection.

28. The system of claim 27, wherein the licensed content comprises user-provided licensed content.

29. The system of claim 26, wherein the licensed content and the user-provided content are independently selected from text, a symbol, an image, an audio clip, a movie or a portion thereof, a video clip, or a combination thereof.

30. The system of claim 29, wherein the image comprises a digital or digitized photograph, a drawing, a scanned document, a video frame or frames, a digitally generated object, or a graphic design.

31. The system of claim 26, further comprising a payment receipt interface.

32. The system of claim 31, wherein the payment receipt interface accepts one or more of a credit card, a debit card, a bank card, a personal check, cash, gift card, gift certificate, coupon, or an internet pay provider.

33. The system of claim 26, further comprising a distribution system for distributing the license fee to the associated provider or providers.

34. The system of claim 26, wherein the user-indicated medium comprises one or more of local memory, a recordable digital video disc, a recordable compact disc, a recordable optical disk, digitally recordable tape, magnetically recordable tape, a portable memory device, an internet site, a computer, or a printable medium.

35. The system of claim 34, wherein the portable memory device comprises one or more of a laptop, a cell phone, a digital camera, a video camera, a personal computer card, a PCMCIA card, a personal digital assistant, a memory card, a memory stick, a flash drive, or a portable media player.

36. The system of claim 34, wherein the system further comprises a printer, and the user-indicated medium comprises printable medium comprising an ink jet receiver, a thermal print receiver, a laser print receiver, a postcard, a photographic base, a label, a cloth, a transfer medium, or a novelty item.
